(19) United States
(12) Patent Application Publication
(10) Pub. No.: US 2014/0244481 A1
(43) Pub. Date: Aug. 28, 2014

(54) ONLINE MULTI PAYMENT SYSTEM

(71) Applicant: Timothy Onyenobi, Manchester (GB)

(72) Inventor: Timothy Onyenobi, Manchester (GB)

(21) Appl. No.: 13/776,771

(22) Filed: Feb. 26, 2013

(51) Int. Cl. G06Q 20/22

(52) U.S. Cl. CPC G06Q 20/227
USPC 705/39

(57) ABSTRACT

The disclosed Multi Payment system is a payment mediation system that uses consolidation of payment methods on a merchant's online transaction/purchase page when a purchase request is made by a purchaser offering multiple payment options from different payment methods available to the purchaser all within a single online transaction. The purchase system presents the purchaser with the purchase amount and a set of payment methods accepted by the merchant to derive a common set of available payment methods available to the purchaser. The system then provides the purchaser the option of selecting a most preferred form of payment or consolidating payment by any combination of payment methods available to the purchaser through multiple entries of such payment methods on the system which adds up to the purchase amount of any of the goods and/or services. The system processes the payments by accepting payment for goods and/or services the purchaser ultimately decides to purchase and/or presenting to the purchaser goods and/or services their eventual payments cover. Upon satisfaction of payments required for any of the goods and/or services the purchaser desires, the merchant accepts all payments in full for such goods and/or services required by the purchaser and consummates the sale within that transaction.

### BACKGROUND OF THE INVENTION

1. Field of the Invention

This invention relates to online purchase systems and methods for electronically transacting the purchase of goods and/or services between a purchaser and a merchant. The invention further relates to such purchase systems and methods for facilitating purchase transactions over a network, and particularly, through any electronic terminal in such a network which includes but is not limited to mobile phones, tablet computers, desktop computers, notebook computers, laptop computers, POS terminals, televisions, or any interactive device that can use the network system. This invention eases purchase by presenting the purchaser with the ability of consolidating their purchase transactions through a variety of payment methods.

2. Description of the Related Art

Recently, online purchase of goods and/or services involves the use of different modes of payment. When the purchaser is prompted to pay for goods and/or services, a typical purchaser usually has the ability to pay for the items using any one of many different payment methods. It is not unusual that the purchaser possesses many payment options in the form of cash, a bank debit card, various types of credit cards, an e-payment solution/provider or through a variety of payment solutions/accounts available to them. However, it is possible for the purchaser to possess funds spread across multiple payment methods acceptable to the merchant yet with insufficient funds in any single one of those methods.

The merchant would in some cases provide a particular payment method(s) that the purchaser might not wish to use. The problem in some cases is not the lack of funds but the unavailability of sufficient funds within any of the purchasers' individual payment methods to cover the total cost of goods and/or services within that single transaction.

For this to happen, purchasers have to ensure their payment method/account has sufficient credit to complete such transaction. Situations arise where the purchaser does not have the luxury of knowing the balance available on each payment method but have a general knowledge of their ability to purchase the goods; in some cases they choose to forgo the purchase with the realisation of insufficient funds on a single payment method. In other cases the purchaser might not want to go through the tedious process of transferring from one account to the primary payment method.

Since, these purchases are only possible through a single payment method the purchaser can choose to either get in contact with their payment method/account provider and resolve the issue with whatever means provided or select another payment method linked to reserved funds in a bid to replenish later. The method with the reserved funds if though sufficient to pay for the transaction, if used might be difficult to replenish due to activities, lack of remembrance, distraction; hence, disrupting the original intention of the reserved funds.

In other words, the purchaser can be saved a lot of time and effort by simply giving them an opportunity to resolve all these issues with a payment system that takes into account all payment methods available to the purchaser at that point in time.

### SUMMARY OF INVENTION

This invention provides an online mediating system for any payment method which uses suitable consolidated payments to meet the full purchase amount for a desired good which a purchaser has requested from a merchant; the system ensures that the purchaser has sufficient funds for the selected payment method(s) which they selected for their purchase and provide a Multi Payment System (Multi-Pay system) that allows the purchaser to pay for the full amount of the good(s) and/or service(s) by making bits of payment from different payment card(s) or payment method(s) all in a single online transaction/purchase.

It is another object of the invention that provides intelligent interactions to the purchaser on their selected purchase terminal or device to ensure that they know which desired payment methods they have chosen can or has covered the good(s) and/or service(s) offered by the merchant through interactions with the merchant database and purchaser database ensuring that the merchant receives full payment for such good(s) and/or service(s) sold.

It is yet another object that assists a purchaser in automatically or manually splitting the total figure of payments for a purchase into parts which can be in financial units or as a percentage based on purchaser's preference and allow for secure entry of one or more payment methods which should be for the full payment of good(s) and/or service(s) with a merchant.

It is yet a further object that calculates a purchaser's outstanding balance and gives them the option of completing said balance with an alternative payment method or the freedom to add and/or remove good(s) and/or service(s) in their purchase request or ultimately opt out of their purchase.

To achieve the foregoing objects, the present invention is designed so that it is activated when payments are due to be made in any given online transaction. Payment details can be stored on the system unless the purchaser opts not to in which case they are discarded either when confirmation of payment has been received from the merchant or the purchaser decides to cancel their purchase.

### BRIEF DESCRIPTION OF THE INVENTION

The present invention is of a system where online purchasers can make purchase using multiple payment methods and credit or debit cards to pay for good(s) and/or service(s) all in a single transaction. This payment can be done for a single good or service and for multiple goods or services using two approaches; a. simultaneous detail input, b. serial payment detail input.

When the purchaser selects a good or service online and gets to the section where payment is required, if the purchaser has bits of money in more than one payment method and cannot make the total payment in a single transaction without having to call up his bank or payment method provider to move funds, this invention provides a platform where the purchaser can make the payment in a single transaction/purchase. The purchaser does this by inserting the details of the different cards and payment methods and the amount they would like to be deducted from each which will equal the total sum of purchase per transaction/purchase and then click pay to complete payment (simultaneous detail input). Alternatively, the system allows the purchaser insert payment details and pay for each good and/or service through one card or payment method one after the other in the same transaction/purchase which also adds the figures incrementally towards the purchase amount to be paid until the Total amount is paid and the transaction/purchase then ends with a paid in full declaration (serial payment detail input).

### BRIEF DESCRIPTION OF THE DRAWING

For a better understanding of the various merits of the invention, reference is made to the following description in conjunction with the accompanying drawings, in which:

FIG. 1 show purchase information which is found in a page (e.g. shopping basket) where selected good(s) “X” or service(s) “Y” to be purchased online is listed according to their price tags, and sum total of money to be paid (in bold font).

FIG. 2 shows a good(s) “X” and sample price ($15) for the good which is being purchased online.

FIG. 3 shows a service(s) “Y” and sample price ($30) for the service which is being purchased online.

FIG. 4 shows the sum total of the amount to be paid for in this transaction ($45 in bold font) using simultaneous detail input approach.

FIG. 5 shows the first payment made ($10) from a payment method e.g. card, which forms part of a total payment ($45) of which the balance ($35) is to be made using other payment methods or cards in order to complete the balance for the same good “X” and/or services “Y” in a single transaction/purchase. Here card detail is provided to complete first part payment of $10.

FIG. 6 shows how the balance of $35 can be paid in full or further in bits using the same process in FIG. 5 all in the that single transaction/purchase by using different payment card(s) or payment method(s).

FIG. 7 shows that the entire has been paid in full ($45 in bold font) in multiple parts and by multiple payment methods using the serial payment detail input (one part completed before the next in a single transaction/purchase).

FIG. 8 is a flow diagram illustrating the operation of the Multi-Pay system for the purchase of goods and/or services.

FIG. 9 illustrates a diagrammatic view of an online purchasing system being used by this invention over a network and with various remote terminals.

### DETAILED DESCRIPTION OF THE DRAWING

The present invention is a payment mediation system for online payment of goods and services where online purchasers make payments for good(s) “X” and/or service(s) “Y” in a single transaction/purchase using different payment methods. Purchasers can easily make payments for what they have purchased online using different credit and debit cards or alternate payment methods by specifying payment at once or in parts which all adds to the total price of good(s) “X” and/or service(s) “Y” for that particular transaction/purchase. This invention carefully takes into consideration the possibility of a purchaser submitting all the card and/or payment detail according to the amount that is to be deducted from each and then clicks to submit and then the full payment is then taken by the merchant (simultaneous detail input) or making each parts of the payment one after the other in that single transaction/purchase until the full payment is made (serial payment detail input). For the serial payment detail input, payments already made can be refunded to the purchaser by the merchant if the final part to complete the payment is not made.

This Multi-Pay system is limited to online payment for a good(s) “X” and/or service(s) “Y” in a single transaction/purchase using different payment methods. Payment is made in parts towards the total figure for that good or service “X” using multiple payment methods (different credit or debit cards, payment gateways, acquirers etc) simultaneously or one complete part payment after the other all in a single transaction/purchase to make up the total payment figure required to make that purchase for the good(s) “X” and/or service(s) “Y”. For example, a purchaser can use their PayPal account to pay for 20%, American express credit card to pay 10%, bank of America bank card to pay 40%, and Diners Club credit card for the remaining 30% of the total price of any single or multiple good and/or service all in a single transaction/purchase. The above payments need to be made such that the part payments from different cards or payment methods will add up to the total sum of goods or services the purchaser seeks to purchase. If the different payments parts don't add up to the required total sum of purchase, the transaction/purchase is then considered incomplete by the Multi-Pay system hence, for the simultaneous detail input no money is taken from purchaser and for the serial payment detail input, the already taken part of the payment is returned and the merchant reserves the right to charge the purchaser for the incomplete transaction/purchase.

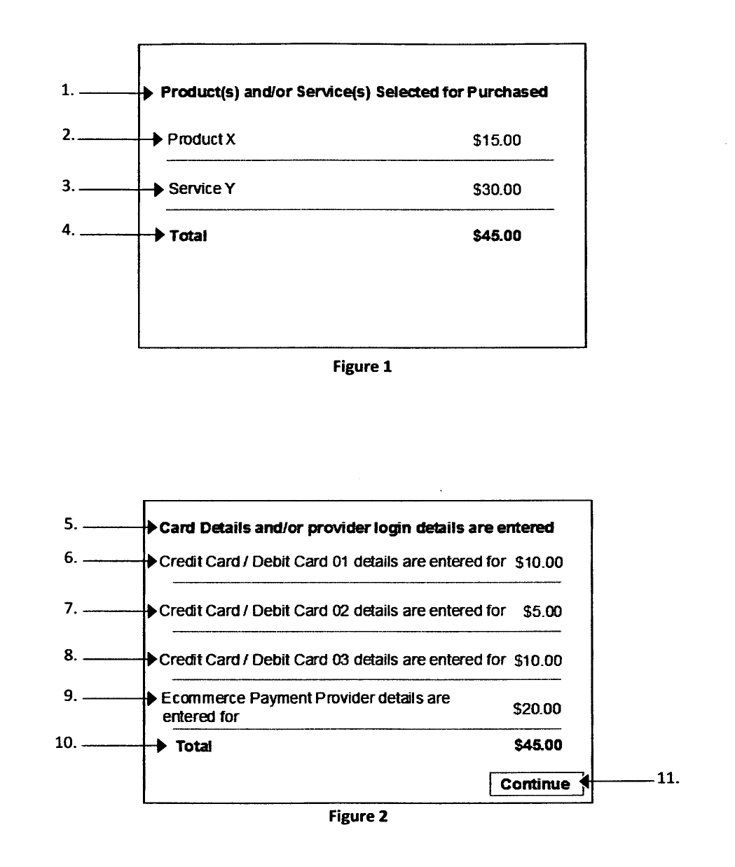

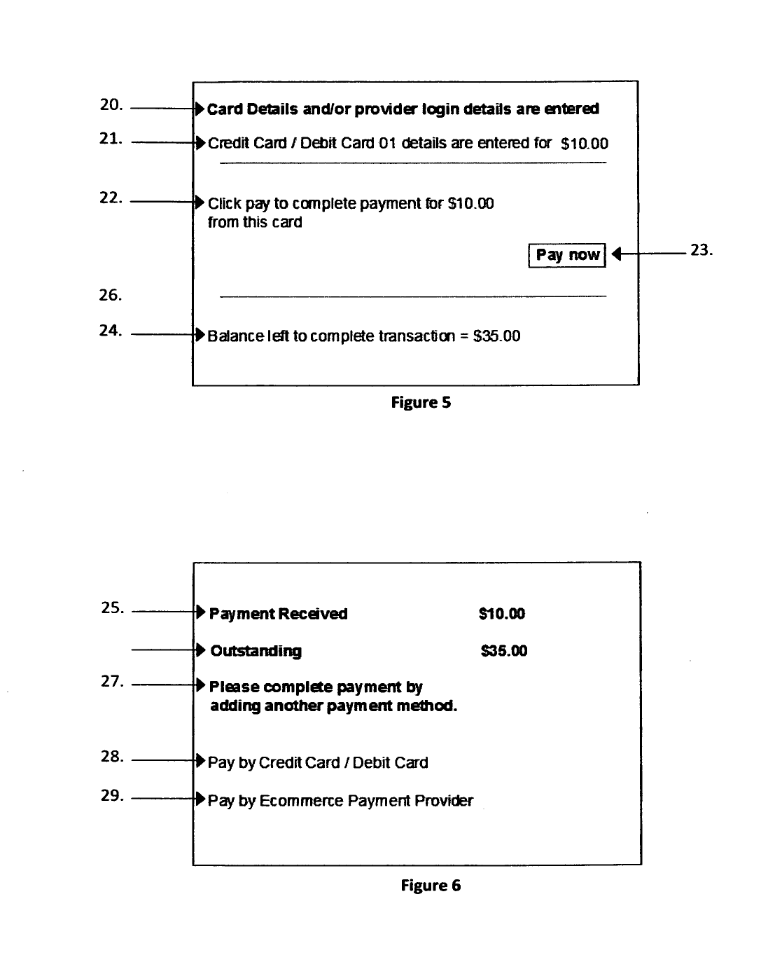

FIGS. 1, 2, 3 and 4 describe the simultaneous detail input method within the Multi-Pay system. FIGS. 5, 6 and 7 describe the serial payment detail input method within the Multi-Pay system.

FIG. 1, this is a page online showing what the purchaser has requested 1. The purchaser has just requested for good(s) “X” ($15) 2 and/or service(s) ($30) 3. Also on this online page is the total price of purchase ($45) 4 which is the amount to be paid in this transaction. The good(s) and/or service(s) can either be single or multiple.

FIG. 2, this is the online page within the Multi-Pay system provided by merchant requesting the purchaser to input details of the payment method and also the amount of money to be taken from each of these payments sources 5. The total payment to be taken must add up to total sum of purchase ($45) 10. The user in this cased, used three card payments and one Ecommerce payment provider all belonging to the purchaser. The first card payment (Card 01) was to have $10 deducted from it 6. The second card (Card 02) was to have ($5) deducted from it 7. The third card (Card 03) was to have ($10) deducted from it 8. The fourth payment method (Ecommerce payment provider) was to have ($20) deducted from it 9. Only details to implement each of these respective payments have been inputted at this stage, the payment has not been processed or taken. However, having filled in the payment details and amount to be taken 6, 7, 8, 9, all adding up to required total ($45) 10, the button to proceed with the transaction/purchase is clicked which in this case is the “continue” button 11.

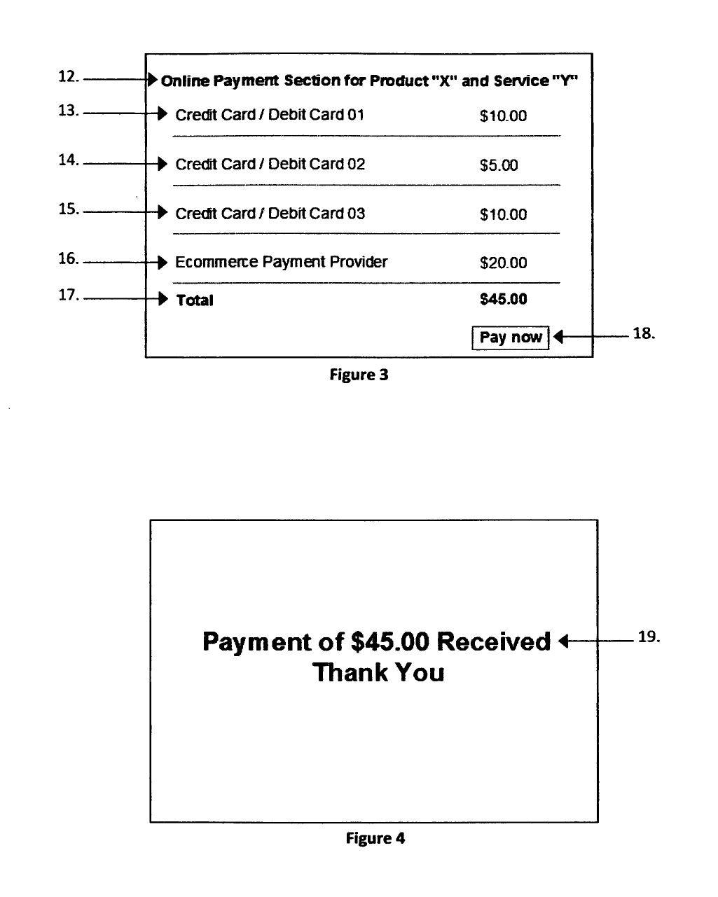

FIG. 3, as the “continue” button is clicked within the Multi-Pay system, the web site acknowledges the payment details and total figure. The page has the payments to be taken from each respective payment method; Credit Card/Debit Card 01 ($10) 13, Credit Card/Debit Card 02 ($5) 14, Credit Card/Debit Card 03 ($10) 15, Ecommerce Payment Provider ($20) 16 and the total purchase price 17 for that particular single transaction/purchase. The purchaser then is required to confirm and execute payment by clicking the relevant button which in this example is the “Pay now” button 18 which then takes the payment which is the total FIG. 17.

FIG. 4, the different amounts which are taken from these multiple payment methods/accounts within the Multi-Pay system at the same time (simultaneous detail input) are added up to the total FIG. 17 which is then confirmed as having been received by merchant. Only then will the good(s) and/or service(s) be confirmed to be dispatched or made available to purchaser.

FIG. 5, also in making the same payment described in FIGS. 1, 2, 3 and 4 using the serial payment detail input within the Multi-Pay system, the part payments are processed one after the other in a single transaction/purchase until complete total payment is made. There is a request by the merchant to insert card details 20 for the first part payment of ($10) 21. Another page or same page can be used to collect card details and the amount to be collected which forms part of the total with a request to complete that payment (not complete the transaction/purchase) 22. The balance to complete transaction/purchase is shown on the page for the purchaser's information 24. A button which will cause the payment to be processed can be clicked to proceed; in this example it is the “Pay now” button 23.

FIG. 6, this part payment cycle within any single given transaction/purchase which is described in FIG. 5 is repeated. The repetition of the part payment cycle within the Multi-Pay system to meet the required total figure will depend on how many payment methods the purchaser has his funds spread across. At this point the payment received is shown to purchaser 25, the balance or outstanding payment figure is also shown 26. The purchase is not complete at this point, though the part payment has been received by merchant, as full payment has not been made the transaction/purchase is not considered complete hence the purchaser is asked to complete 27. There are provisions (in same or another webpage) for the purchaser to insert another card 28 or Ecommerce payment provider detail 29 to make another part payment towards total payment or to complete payment balance.

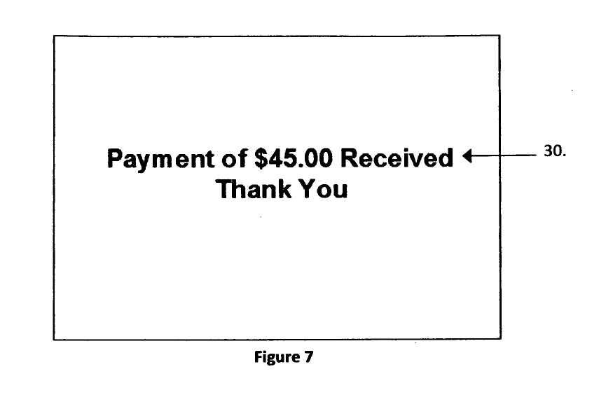

FIG. 7, the different amounts have at this point been taken from purchaser through these multiple payment methods/accounts, one payment after the other (incrementally) for that particular transaction/purchase (serial payment detail input). The payments taken which add up to the total FIG. 30 is then confirmed as having been received by merchant and only then will the good(s) and/or service(s) be confirmed to be dispatched or made available to purchaser.

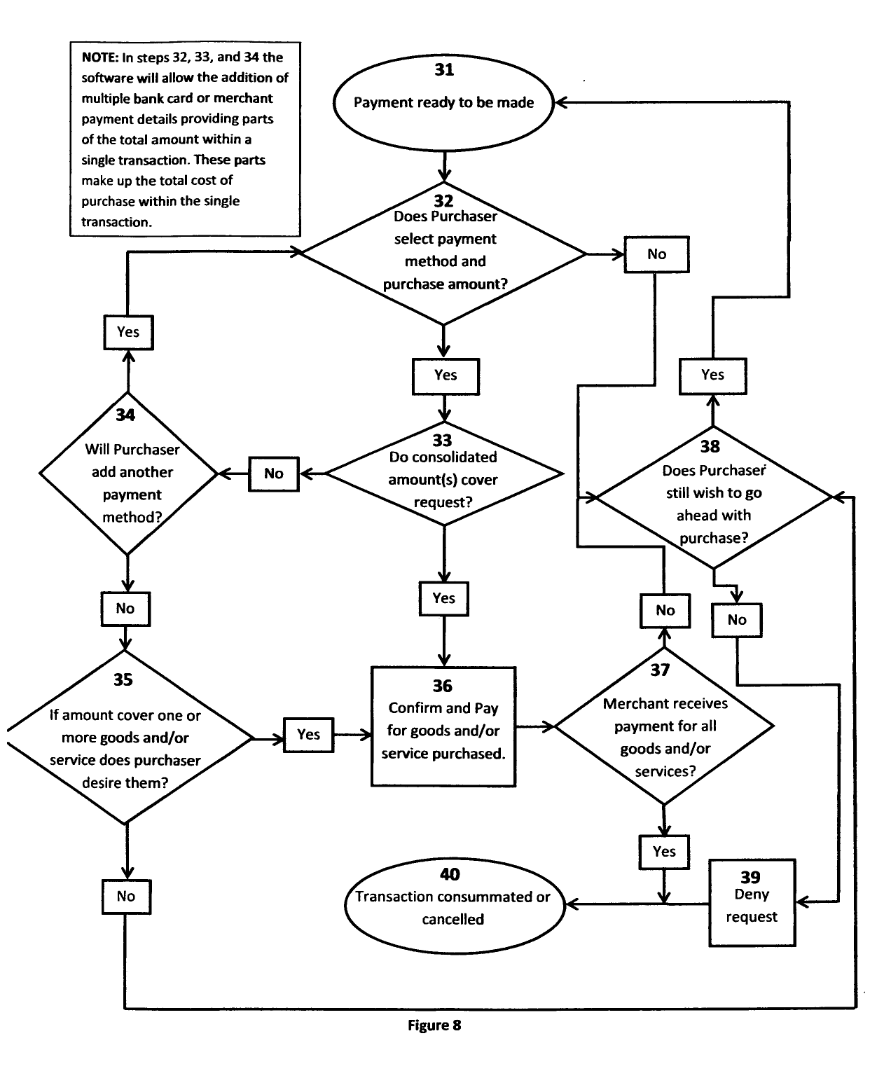

FIG. 8 illustrates the basic logic of the Multi-Pay system via a flow diagram. The process starts at step 31, when the purchaser is ready to make payments for their purchase to 40, where the transaction/purchase has been completed by either consummation of the request done by the merchant or cancellation by the purchaser. Steps 32, 33 and 34 illustrate the consolidation nature of the Multi-Pay system which can be done in any number of pages. In step 32, the purchaser goes through the selection of payment method they want to use and the desired amount they impose on themselves from this payment method. If they do not want to go ahead with the payment methods and/or purchase amounts, they have to confirm this in step 38 which then takes them to step 39 and ultimately step 40. The system interacts with the purchaser to determine in 33, if the amount the purchaser imposed on themselves cover full payment for the purchase request they made before moving on to confirmation of payment in step 36. If the amount the purchaser has imposed on themselves does not cover full payment, step 34 shows that the purchaser has to add another payment method and amount which is consolidated to previous ones by addition of all imposed amounts until the sum of all imposed amounts as a whole covers the purchase request before full payment is confirmed in 36. Alternatively, step 35 shows that the purchaser is given the option of purchasing what they desire if their imposed desired amounts cover at least one good and/or service. If they still want more goods and/or services they arrive at step 38 which takes them back to the decision of payment ready to be made. At step 36, they confirm payment for the goods and/or services and at step 37, the merchant either receives payment through the payment method they desire in real time or receive a notification so they can consummate transfer in step 40 and the process ends. If the payment is not received in full the purchaser is notified of the merchant not receiving payment and asked if they still want to continue with the purchase at step 38. If the purchaser still desires it, they can go back to the start of the process but if the purchaser decides they want to cancel their purchase the next step will be step 39 which in essence cancels the transaction/purchase at the request of the purchaser. This in turn leads to step 40 where the transaction/purchase is cancelled and the process ends.

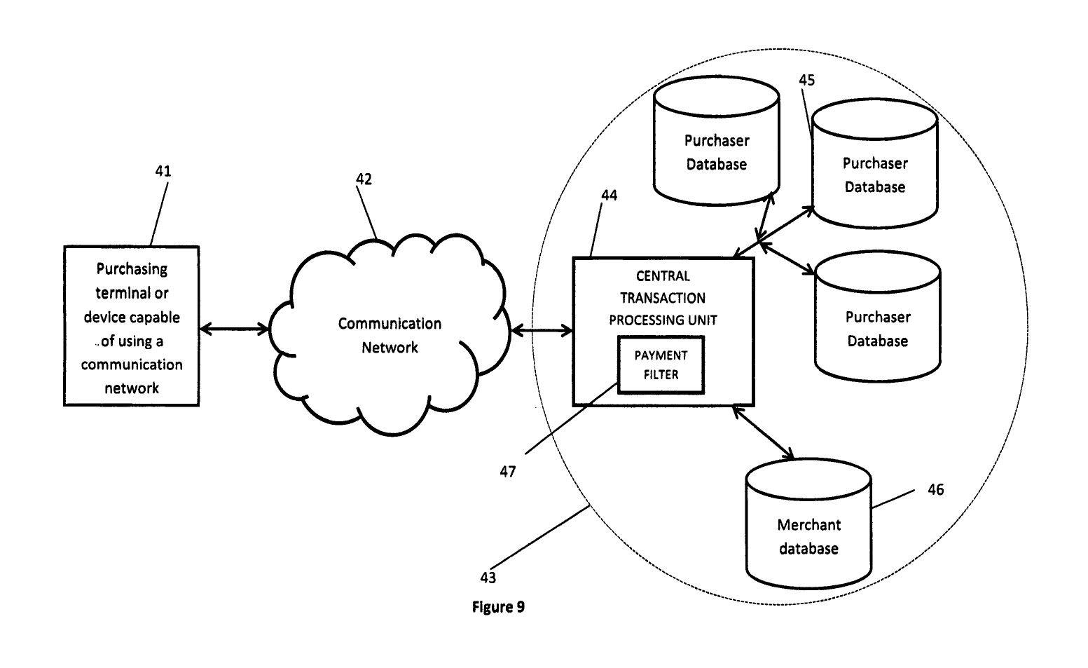

FIG. 9 shows a diagrammatic representation of an online purchasing system or the Multi-Pay system 44 at work which is done over a communication network 43 via interactions between the entire composition of the Multi-Pay system and the purchasing terminal 41 of the purchaser across the communication network. The Multi-Pay system is comprised of a centrally located transaction processing unit 44, linked up to a merchant database 46 and purchaser database 45. The merchant database 46, maintains a list of merchants along with their financial information. This financial information, amongst other things, includes a set of each merchant's accepted payment methods. The merchant is willing to accept any one of its set of payment methods for the sale of goods and/or services. The purchaser database 45, maintains a list of purchasers along with their personal financial information. This financial information, amongst other things, includes a set of personal payment methods which are provided by the purchaser. A purchaser can use any one of these set of personal payment methods to purchase goods and/or services.

The purchaser can store their account balances and impose spending limits on the database so the Multi-Pay system can retrieve and display them when needed by the purchaser and as such a purchaser can register to use the system so that the invention is much able to quickly assist the purchaser. The central transaction processing unit contains a payment filter 47. Preferably, the payment filter is implemented as a software program running on the transaction processing unit 44, or as complementary software running at both the transaction processing unit and one or more purchasing terminals.

In its most secure form, the central transaction processing unit 44 contains a filter 47 which interacts with the purchasing terminal's processing unit and filters out the set of a purchaser's personal payment methods that corresponds to the set of a merchant's accepted payment method on a purchase request made by the purchaser. This is displayed to the purchaser via the purchasing terminal 41. Through the interaction of the purchaser, the transaction processing unit evaluates, assess and display to the purchaser a set of payment methods unique to the purchaser and merchant from the purchaser database and merchant database and that the purchaser can use for purchase of goods and/or services.

The purchaser makes the purchase request from the terminal 41, over a communication network which is first received by the central transaction processing unit. This derives a set of accepted payment methods from linking the merchant and purchaser database together to derive a common set of payment methods and displays it to the purchaser. The purchaser then chooses to pay by using a single payment method from the displayed list or through consolidation of multiple payment methods to achieve the desired purchase price for the good(s) and/or service(s) requested by the purchaser.

1. An online purchase system comprising;
a Multi-Pay system which is a payment mediation system used in purchase requests for desired goods and/or services through the consolidation of available payment methods that will count towards the entire purchase price of such good(s) and/or service(s) in any combination and in a single transaction/purchase which can be within any number of pages;
the full purchase amount is achieved when all consolidated payment methods are processed at once as long as the purchase amount received is a total of all consolidated payment amounts being processed and the respective payment method(s) have been provided by purchaser on relevant pages;
consolidation can also be done through simultaneous increments by processing one payment method after another until such a time that the sum of payments being made eventually, covers the purchase amount for desired good(s) and/or service(s) the purchaser requires all within a single transaction/purchase.

2. An online purchase system as recited in claim 1 wherein:
it is comprised of a purchaser database having a list of purchasers, the purchaser database also storing numerous sets of purchasers payment method information whereby any individual purchaser could use any one of the personal payment methods within their respective set to purchase goods and/or services through a single payment or consolidated sets of payment(s);
a merchant database with a list of merchants, the merchant database also storing numerous sets of merchants accepted payment method information whereby any individual merchant could accept any one of the payment methods within their respective set for sale of goods and/or services through a single payment or consolidated sets of payment(s);
a transaction processing unit coupled to the purchaser and merchant databases, the processor also being coupled to receive a purchase request for goods and/or services, the purchase request identifying a merchant and a purchaser;
the transaction processing unit accessing the merchant database according to the merchant identified in the purchase request to retrieve the set of many accepted payment methods which corresponds to that merchant, the processor also accessing the purchaser database according to the purchaser identified in the purchase request to retrieve a set of many personal payment methods which corresponds to that purchaser;
the transaction processing unit computing an intersection of these two sets to derive a common set of any available payment method that is both accepted by the merchant and can be used by the purchaser for purchase of the goods and/or services; and
the transaction processing unit derives and displays to the purchaser a current set of payment methods which the purchaser intends using in their purchase request by intersecting matching sets of payment methods from the purchaser and merchant database.

3. An online purchase system as recited in claim 1 wherein:
It is comprised of a merchant database with a list of merchants, the merchant database also storing a set of many accepted payment methods for corresponding ones to each merchant whereby an individual merchant is willing to accept any one of the accepted payment methods in that merchant's corresponding set for sale of the goods and/or services as a single accepted payment method or consolidated sets of accepted payment methods;
a purchaser database having a list of purchasers, the purchaser database also storing a set of many personal payment methods for corresponding ones to each purchaser whereby an individual purchaser could use any one of the personal payment methods in that purchaser's corresponding set to purchase goods and/or services as a single payment method or consolidated sets of payment methods;
the purchaser database is such that information is stored temporarily until such a time that the purchaser requires and acquires unique signing keys which gives such information as much storage as desired by the purchaser or the purchase request is deemed fully processed;
the merchant database is coupled to the transaction processing unit such that a purchaser can make a purchase request and a set of available payment methods is made available to the purchaser;
the transaction processing unit is coupled to the merchant database and an entry field for the purchaser on the merchant's site, the processor also being coupled to receive a purchase request for goods and/or services, the purchase request identifying a merchant and a purchaser;
the transaction processing unit is coupled to the merchant and purchaser databases, the processor also being coupled to receive a purchase request for goods and/or services, the purchase request identifying a merchant and a purchaser;
the transaction processing unit derives and displays to the purchaser a set of payment methods which the purchaser intends using in their purchase request by intersecting matching sets of payment methods from the purchaser and merchant database.

4. An online purchase system as recited in claim 1 wherein:
the purchase request further includes a purchase amount;
the purchaser imposes on themselves personal spending limits for payment methods which they intend using on current or future purchase requests;
the Multi-Pay system allows for a desired entry or multiple desired entries of the spending limits on each payment method for goods and/or services the purchaser desires.

5. An online purchase system as recited in claim 1 wherein:
the transaction processing unit accessing the merchant database according to the merchant identified in the purchase request to retrieve the set of many accepted payment methods which corresponds to that merchant,
the transaction processing unit displaying to the purchaser the set of many personal payment methods accepted by the merchant,
the transaction processing unit computing an addition of common set of available payment method that is both accepted by the merchant and can be used by the purchaser for purchase of goods and/or services;
the transaction processing unit interacts with the purchaser in selecting a single or multiple desired set of available payment methods include a personal purchase amount for each of purchaser's desired common set of payment methods and;
the transaction processing unit storing to the purchaser database personal purchase information according to the purchaser identified in the purchase request to the set of desired payment methods which corresponds to that purchaser.

6. An online purchase system as recited in claim 1 wherein:
the purchase request further includes a purchase amount;
the purchaser database includes personal purchase allowances for associated purchasers, each personal purchase allowance being imposed by the purchaser to prevent an expenditure in excess of the personal purchase allowance;
the transaction processing unit evaluates whether the purchase amount contained in the purchase request exceeds a sum of personal purchase allowance associated with the identified purchaser.

7. An online purchase system as recited in claim 1 wherein:
the purchase request further includes a purchase amount;
the Multi-Pay system notifies the purchaser of any balance left in the purchase amount;
the Multi-Pay system communicates with the purchaser to evaluate if the purchaser would like to change their personal spending limits or personal purchase allowance based on their current purchase request.

8. An online purchase system as recited in claim 1 wherein:
the purchase request further includes a purchase amount;
the purchaser adjusts purchase allowances to corresponding ones of the personal payment methods for related purchasers; and
the Multi-Pay system evaluates whether the purchase amount contained in the purchase request exceeds an account balance of any available payment method in the common set.

9. An online purchase system as recited in claim 1 wherein:
the purchaser database includes unique signing keys for creating digital signatures for corresponding ones of the purchasers;
the Multi-Pay system creates a digital signature on behalf of the identified purchaser to authorize the purchase of the goods and/or services;
the Mutli-Pay system assigns a unique identifier for any purchaser without unique signing keys.

10. A purchasing system for use on an interactive network, the purchasing system comprising:
a centrally located transaction processing unit;
a merchant database provided at the transaction processing unit, the merchant database having a list of merchants and sets of accepted payment methods for corresponding ones of the merchants, whereby an individual merchant is willing to accept any one of the accepted payment methods in that merchant's corresponding set for sale of the goods and/or services;
a purchaser database provided at the transaction processing unit, the purchaser database having a list of purchasers and sets of personal payment methods for corresponding ones of the purchasers, whereby an individual purchaser could use any one of the personal payment methods in that purchaser's corresponding set to purchase the goods and/or services;
multiple purchasing terminals located remotely from the transaction processing unit, each purchasing terminal having an input device which can receive a purchase request from a purchaser to buy goods and/or services from a merchant, the purchase request identifying the merchant and the purchaser;
an interactive communication network which interfaces the remotely located purchasing terminals with the centrally located transaction processing unit, the communication network transferring the purchase request from one of the purchasing terminals to the transaction processing unit;
the transaction processing unit accessing the merchant database according to the merchant identified in the purchase request to retrieve the set of accepted payment methods which corresponds to that merchant, and further accessing the purchaser database according to the purchaser identified in the purchase request to retrieve the set of personal payment methods which corresponds to that purchaser; and
a payment method filter operable to receive the set of merchant accepted payment methods and the set of personal payment methods and to compute an intersection of these two sets to derive a common set containing any available payment methods that is both accepted by the merchant and can be used by the purchaser for purchase of the goods and/or services.

11. A purchasing system as recited in claim 8 wherein:
the payment method filter resides at the transaction processing unit; and
the transaction processing unit transfers the common set back to the one purchasing terminal via the communication network to inform the purchaser of any available payment methods.

12. A purchasing system as recited in claim 8 wherein:
multiple payment method filters provided to function at individual respective purchasing terminals; and
the transaction processing unit transfers the set of accepted payment methods retrieved from the merchant database and the set of personal payment methods retrieved from the purchaser database back to the one purchasing terminal via the communication network whereby a payment method filter resident at the one purchasing terminal computes the common set to inform the purchaser of any available payment methods.

13. A purchasing system as recited in claim 8 wherein:
the transaction processing unit and payment method filter do not reveal to the merchant the set of personal payment methods of the purchaser.

14. A purchasing system as recited in claim 8 wherein:
the purchase request further includes a purchase amount;
the purchaser database includes account balances for corresponding ones of the personal payment methods for related purchasers;
the one purchasing terminal presents the common set of available payment methods to the purchaser for selection whereby the purchaser selects a desired payment method using the input device at the one purchasing terminal;
the transaction processing unit evaluates whether the purchase amount contained in the purchase request exceeds an account balance of the selected payment method;
In the event that the purchase amount exceeds the account balance of the selected method, the purchasing terminal presents to the purchaser the option of either selecting another purchase method or adding another available payment method from the common set of selection to the current payment method;
in the event that the purchaser chooses another payment method, the purchasing terminal presents to the purchaser another available payment method from the common set for selection;
In the event that the purchase chooses addition of another payment method to the current payment method, the purchasing terminal presents an additional payment method from the common set of selection.
